(19) United States
(12) Patent Application Publication
(10) Pub. No.: US 2011/0278199 A1
(43) Pub. Date: Nov. 17, 2011

(54) Corner Protector Apparatus for a Medical Sterilization Container and Method Thereof

(75) Inventors: Gary T. Dane, Bow, NH (US); Valentine T. Faust, III, Bow, NH (US)

(73) Assignee: Symmetry Medical USA, Inc., Warsaw, IN (US)

(21) Appl. No.: 13/087,722

(22) Filed: Apr. 15, 2011

Related U.S. Application Data
(60) Provisional application No. 61/334,272, filed on May 13, 2010.

(51) Int. Cl. B65D 81/02; B23P 17/00

(52) U.S. Cl. 206/586; 29/525.01

(57) ABSTRACT

A method and apparatus for a medical sterilization container corner protector is provided. The medical sterilization container corner includes a corner protector structure sized to removably engage with a corner of the medical sterilization container. A fastening structure is disposed on the corner protector. A fastening mechanism is engaged with the fastening structure, wherein the fastening mechanism biases the corner protector towards the corner of the medical sterilization container.

### CROSS REFERENCE TO RELATED APPLICATION

This application claims benefit of U.S. Provisional Application Ser. No. 61/334,272 filed May 13, 2010, the entire disclosure of which is incorporated herein by reference.

### FIELD OF THE DISCLOSURE

The present disclosure is generally related to medical sterilization containers and more particularly is related to corner protectors for medical sterilization containers.

### BACKGROUND OF THE DISCLOSURE

In hospitals, surgery centers, and other healthcare facilities, surgical instruments must be sterilized prior to use. Normally, surgical instruments are placed in a surgical tray, which is wrapped in a sterilization wrap to protect the instruments from subsequent contamination. The wrapped surgical tray is then inserted into an autoclave and sterilized.

After sterilization, the wrapped tray is placed on a storage shelf or cart until it is needed for a surgical procedure. When the surgical instrument sterilization tray is needed, it is delivered to the operating room. Before the surgical tray is unwrapped, the integrity of the sterilization wrap is inspected to ensure that it does not contain any rips, tears or holes. If the wrap is compromised, the instruments are considered contaminated and cannot be used.

Most sterilization wrap is susceptible to tearing and ripping. Handling by hospital staff is the primary cause of ripping of sterilization wrap on a surgical tray. Many of the surgical trays used in healthcare facilities are heavy and/or have sharp corners. When the wrapped surgical tray is slid across a surface, instead of being directly lifted, the corners of the surgical tray can puncture the wrap, thus destroying the sterile environment in which the surgical instruments are stored.

Some products for container corner protection are currently available, however these products are known to fail because they do not stay affixed or proximate to the corner of the container. Thus, when a container with one of these corner protection products is lifted or moved, the product falls off the container and leaves the sterilization wrap susceptible to being torn. If the sterilization wrap on a surgical tray is torn, the surgical instruments must be rewrapped and sterilized again, which results in reprocessing costs and takes up staff time. In addition, surgical procedures may consequently be delayed. Thus, there is a need in the art for a surgical tray corner protection that will prevent sterilization wrap surrounding a sterile surgical tray from being ripped or torn by the corners of the tray, and, therefore, rendering the surgical instruments unsterile.

### SUMMARY OF THE DISCLOSURE

Embodiments of the present disclosure provide a system and method for medical sterilization container corner protector. Briefly described, in architecture, one embodiment of the system, among others, can be implemented as follows. The system contains a corner protector structure sized to removably engage with a corner of the medical sterilization container. A fastening structure is disposed on the corner protector. A fastening mechanism is engaged with the fastening structure, wherein the fastening mechanism biases the corner protector towards the corner of the medical sterilization container.

The present disclosure can also be viewed as providing a medical sterilization container corner protector having at least a first corner protector structure and a second corner protector structure, each of the first and second corner protector structures having a base and at least one sidewall, wherein each of the first and second corner protector structures are sized to removably engage with a first corner and a second corner, respectively, of the medical sterilization container. At least a first fastening structure is disposed on the first corner protector structure. At least a second fastening structure is disposed on the second corner protector structure. A fastening mechanism is engagable between the first and second fastening structures, wherein the fastening mechanism biases each of the first and second corner protectors towards the first and second corners, respectively, of the medical sterilization container.

The present disclosure can also be viewed as providing a method for protecting a corner of a medical sterilization container. In this regard, one embodiment of such a method, among others, can be broadly summarized by the following steps: placing a first corner protector structure on a first corner of a medical sterilization container; placing a second corner protector structure on a second corner of the medical sterilization container; and removably fastening the first corner protector structure to the second corner protector structure with at least one fastening mechanism, wherein at least a portion of the medical sterilization container is located between the first and second corner protecting structures.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a plan view illustration of a medical instrument sterilization container corner protector, in accordance with a first exemplary embodiment of the present disclosure.

FIG. 2 is a side view illustration of a medical instrument sterilization container corner protector, in accordance with the first exemplary embodiment of the present disclosure.

FIG. 3 is a side view illustration of a medical instrument sterilization container corner protector, in accordance with the first exemplary embodiment of the present disclosure.

FIG. 4 is a plan view illustration of a medical instrument sterilization container corner protector, in accordance with the first exemplary embodiment of the present disclosure.

FIG. 5 is a plan view illustration of a medical instrument sterilization container corner protector, in accordance with the first exemplary embodiment of the present disclosure.

FIG. 6 is a plan view illustration of a medical instrument sterilization container corner protector, in accordance with the first exemplary embodiment of the present disclosure.

FIG. 7 is a flow chart illustrating a method of protecting a corner of a medical sterilization container, in accordance with the first exemplary embodiment of the present disclosure.

### DETAILED DESCRIPTION

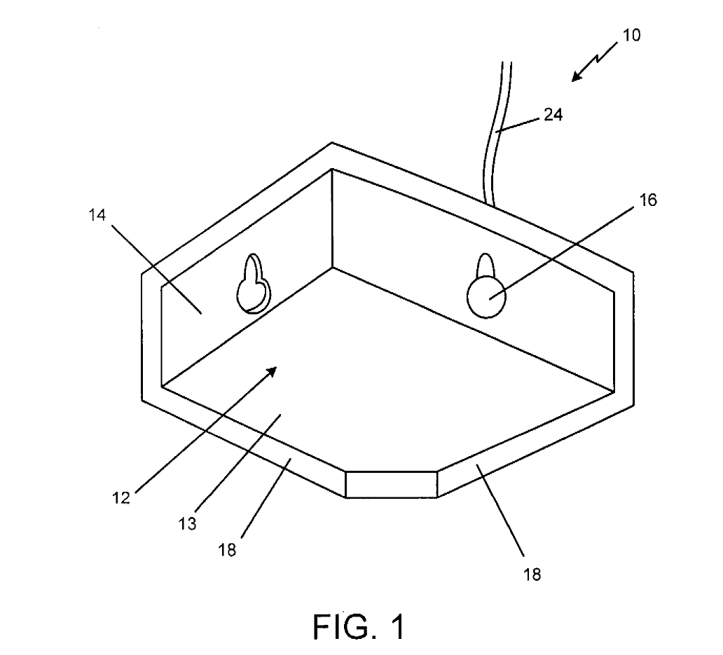

FIG. 1 is a cross-sectional illustration of a medical instrument sterilization container corner protector 10. The medical instrument sterilization container corner protector 10, which may also be referred to as the “corner protector 10,” includes a corner protector structure 12 sized to removably engage with a corner of the medical sterilization container. A fastening structure 16 is disposed on the corner protector structure 12. A fastening mechanism 24 is engaged with the fastening structure 16, wherein the fastening mechanism biases the corner protector structure 12 towards the corner of the medical instrument sterilization container.

The corner protector 10 is designed to abut the corner of a medical instrument sterilization container (hereinafter, “container”) that has a substantially cuboidal structure. However, the corner protector 10 may also be designed for containers that include other shapes, such as containers with rounded corners or edges. When abutting a container, the inside region of the corner protector structure 12 will be located proximate to the exterior surface of the container. The corner protector structure 12 may be any size needed and may generally correspond to the size of the container. The corner protector structure 12 may include a variety of components and design features to enhance the use, convenience and efficiency of the corner protector 10.

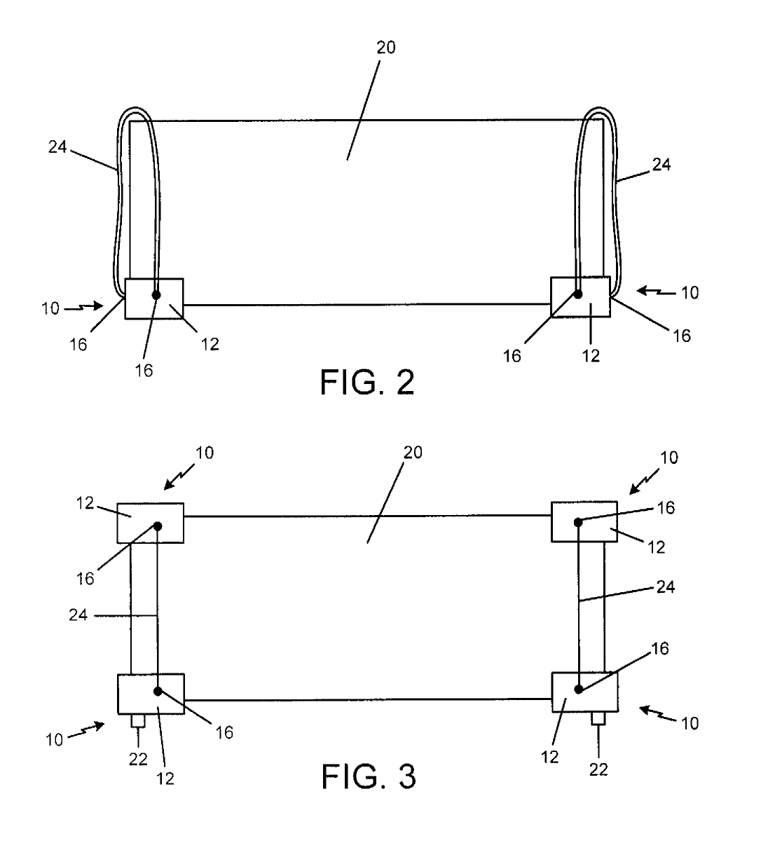

Generally, the corner protector structure 12 may be constructed from a single material, such as molded flexible polymer, or a plurality of different or similar materials affixed together, such as fused plastic composites. The materials used to construct the corner protector structure 12 may be flexible and resilient, such that the corner protector structure 12 retains its general shape, but also conforms to the corner of the container 20 (FIGS. 2-3). Further, the materials used to construct the corner protector structure 12 may be free from destructive features like sharp edges or pointed features, such that any material placed around the outside of the corner protector structure 12, such as a sterile wrap, to be free from tearing or other forms of damage due to the corner protector structure 12.

As is illustrated in FIG. 1, the corner protector structure 12 may include a base 13 and at least one sidewall 14. The base 13 may be a substantially planar structure that is designed to abut the base, or a wall of the container. The at least one sidewall 14 may be located proximate to one or more edges 18 of the base 13. In one example, as shown in FIG. 1, the at least one sidewall 14 is located proximate to two edges 18 of the base 12, affixed to the edge 18 and extending in an outward direction. The sidewall 14 is a substantially planar structure that may extend in at least two planes, which may be substantially perpendicular to each other and connected together. FIG. 1 depicts the sidewall 14 with this configuration. The at least one sidewall 14 may also be a structure that bends, flexes or has curvature, depending on the design. The at least one sidewall 14 may further include other design features, such as tapers, bevels, rounded edges. Other design features are apparent to one having ordinary skill in the art and are within the scope of the present disclosure.

The fastening structure 16 may include a variety of design configurations or attached structures, but is generally characterized as a structure that is used in retaining the corner protector structure 12 in a position abutting a container. For example, the fastening structure 16 may be a key-slot opening in the sidewall 14, as depicted in FIG. 1. In another example, the fastening structure 16 may include a mechanical fastener attached to the sidewall 14, such as a metal hook or a hook and loop system. The fastening structure 16 may be situated to receive a fastening mechanism 24, as discussed more with respect to FIG. 5.

The retaining mechanism 24 may include any device or combination of devices capable of retaining the corner protector structure 12 proximate to the container. Generally, the retaining mechanism 24 may be an elongated device that has elastic properties that allow the retaining mechanism 24 to be stretched. For example, the retaining mechanism may be a silicone stringer that is stretchable and elastic, yet strong enough to provide a constant force on the corner protector structure 12. Other materials may be used as well, as one having ordinary skill in the art would recognize. The retaining mechanism 24 is engagable with the fastening structure 16 of the corner protector structure 12. The engagement between the retaining mechanism 24 and the fastening structure 16 may include a variety of different designs, such as a key-hole design, as is illustrated in FIG. 1.

FIG. 2 is a side view illustration of a medical instrument sterilization container corner protector 10, in accordance with the first exemplary embodiment of the present disclosure. In this illustration, there are two corner protector structures 12 shown in a working position with a container 20. The corner protector structures 12 are positioned proximate to two corners of the container 20, and are retained in that position by the retaining mechanism 24. As can be seen, a first end of the retaining mechanism 24 is affixed to a fastening structure 16 within the corner protector structure 12. The second end of the retaining mechanism 24 is also affixed to a different fastening structure 16 within the same corner protector structure 12. The middle portion of the retaining mechanism 24 is positioned over an opposing corner of the container 20, whereby the retaining mechanism 24 can exert a force on the corner protector structure 12 that keeps it in a position abutting the container 20.

FIG. 3 is a side view illustration of a medical instrument sterilization container corner protector 10, in accordance with the first exemplary embodiment of the present disclosure. In this illustration, there are four corner protector structures 12 shown in a working position with a container 20. The corner protector structures 12 are positioned proximate to four corners of the container 20, and are retained in that position by the retaining mechanisms 24. As was described in FIG. 2, the retaining mechanism 24 retains the corner protector structures 12 in place by exerting a force on the corner protector structures 12 towards the container 20. However, in FIG. 3, the retaining mechanisms 24 are positioned between two corner protector structures 12 that oppose each other. Accordingly, the retaining mechanism 24 exerts an inward force (towards the container 20) on both corner protector structures 12. This may allow for corner protector structures 12 to be applied conveniently to new and existing containers 20, and even be applied over existing container features, such as legs 22.

In accordance with the first exemplary embodiment, it is noted that any combination or configuration of the retaining mechanism(s) 24 may be used. For example, a single container 20 may have corner protector structure 12 with a retaining mechanism 24 that is positioned on an opposing corner of the container 20 and retaining mechanism 24 that is connected to another corner protector structure 12. Furthermore, retaining mechanisms 24 extending along the length, width and height of a container 20 may be used. A retaining mechanism 24 may also be placed diagonal across corners of a container 20.

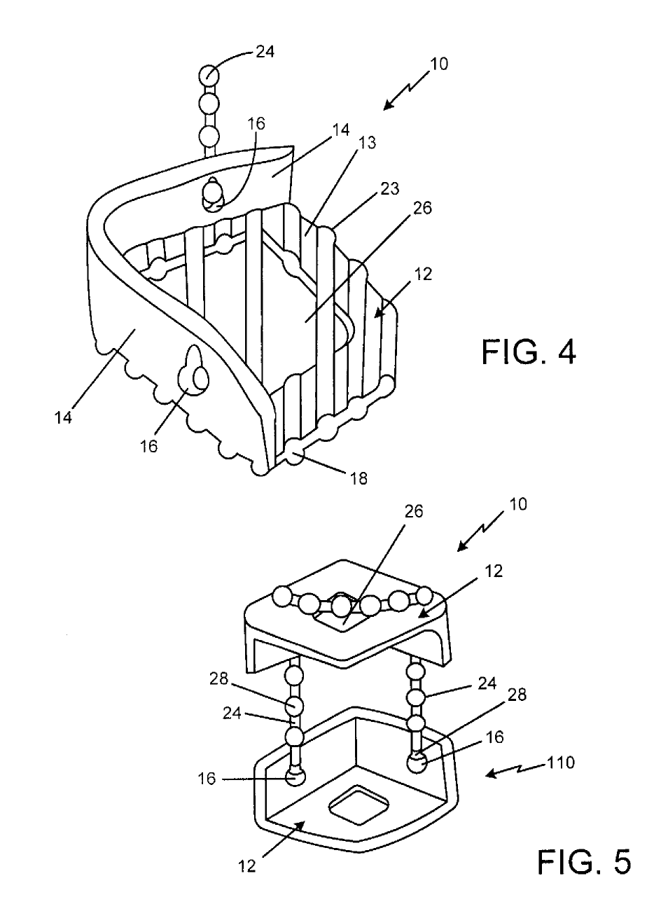

FIG. 4 is a plan view illustration of a medical instrument sterilization container corner protector 10, in accordance with the first exemplary embodiment of the present disclosure. The corner protector structure 12 may include a textured surface 23 that may include a variety of different textures and features. For example, as is illustrated in FIG. 4, the corner protector structure 12 may include a textured surface 23 with a plurality of raised surfaces and a plurality of non-raised surfaces. When the corner protector structure 12 is abutting a container 20 (FIGS. 2-3), the plurality of non-raised surfaces may allow a quantity of moving atmospheric gas, such as air or a sterilization environment gas, to access the space between the corner protector structure 12 and the container 20. This may allow for a more enhanced sterilization, since the atmospheric gas can contact more of the container 20. The corner protector structure 12 may also include a textured surface 23 with a material that has high friction properties or friction enhancing design.

The corner protector structure 12 may also include a cutout element 26 within the base 13. The cutout element 26 may be an aperture, hole, or other absence of material within the base 13 that provides multiple benefits. For example, the cutout element 26 may be sized to fit around a leg 22 or a protrusion of a container 20 (FIGS. 2-3). This may allow the corner protector structure 12 to be properly placed on the corner of a container 20 that has a leg. The cutout element 26 may include a plurality of small apertures, or one, single aperture sized to receive the leg 22 of the container 20. Additionally, the cutout element 26 may allow numerous containers 20 to be stacked, wherein a protruding leg of a first container 20 may lodge within the cutout element 26 of a corner protector structure 12 placed on the upper side of a second container 20, when the first container 20 is placed on the second container 20. Other variations are foreseeable, such as protrusions or other features within the corner protector structure 12 that facilitate convenient stacking of multiple containers 20. Additionally, the cutout element 26 may be used for aesthetic purposes, or to minimize material costs with fabricating the corner protector structure 12. It is noted that any of the features discussed with respect to the base 13 of the corner protector structure 12 may also be applied to any other portions of the corner protector structure 12, including an underside surface of the base 13 and/or the sidewalls 14.

A variety of additional features may be used with the corner protector 10 to enhance the utility, functionality and/or marketability of the corner protector 10. For instance, corner protector structure 12 may be color-coded or include labels, such as a barcode or an RFID tag. This may allow users to properly organize, record and/or locate the containers 20 and corner protectors 10, which in turn may enhance the ease of use and the utility of the corner protectors 10. Particularly, the ability to know whether a corner protector structure 12 is sterilized or unsterilized is important in a medical setting. For example, after a medical practitioner sterilizes a quantity of medical tools within a container 20, it is imperative to retain the medical tools in a sterilized environment until they are used in a medical procedure. To accomplish this, the medical practitioner may wrap the container 20 with the corner protectors 10 in a bacteria-resistant or impervious material, such as a plastic wrap. Since the corner protector structure 12 is placed proximate to the sterile container 20, within the bacteria-resistant material, it too needs to be sterile. Accordingly, the corner protector structure 12 may be sterilized and labeled as such with a textual label or an electronic label. This allows a medical practitioner to readily determine whether the corner protector structure 12 is suitably sterile for medical purposes.

FIG. 5 is a plan view illustration of a medical instrument sterilization container corner protector 10, in accordance with the first exemplary embodiment of the present disclosure. The corner protector 10 includes at least two corner protector structures 12 engaged together with a retaining mechanism 24, but may include any number of corner protector structures 12 engaged together with any number of retaining mechanism 24. The retaining mechanism 24 may be affixed to the fastening structure 16 of one or more corner protector structures 12. The retaining mechanism 24 may connect the two corner protector structures 12 together, such that each is retained in a position abutting a corner of the container 20. The retaining mechanism 24 may connect the two corner protector structures 12 by engaging with the fastening structures 16 of one of the corner protector structures 12 and being placed in a biasing position on the other corner protector structures 12, as is illustrated in FIG. 5. Alternatively, the retaining mechanism 24 may be engaged with the fastening structures 16 of both retaining corner protector structures 12. Any configuration of retaining mechanisms 24 between the corner protector structures 12 is considered within the scope of the present disclosure.

The retaining mechanism 24 may include a variety of designs, materials and configurations. For example, as briefly discussed above, the retaining mechanism 24 may be a silicone stringer that may be retained in the fastening structure 16. Retention of the retaining mechanism 24 may be accomplished by using fastening structure engagement elements 28, which may include flat barbs, spherical balls (shown) or another structure affixed to the silicone stringer at intervals. The fastening structure engagement elements 28 may be retained proximate to the fastening structure 16 such that tension on the retaining mechanism 24 keeps the corner protector structure 12 abutting a corner of the container. Accordingly, the retaining mechanism 24 may allow for a snug fit between the corner protector structures 12 and any sized container. In another example, the retaining mechanism 24 may include a hook and loop fastener, a metallic chain fastener, a plastic retaining structure or similar fastening mechanism. In yet another example, the retaining mechanism 24 may be an integral design of the corner protector structure 12 that engages directly with another corner protector structure 12 or a sidewall 14 of the container.

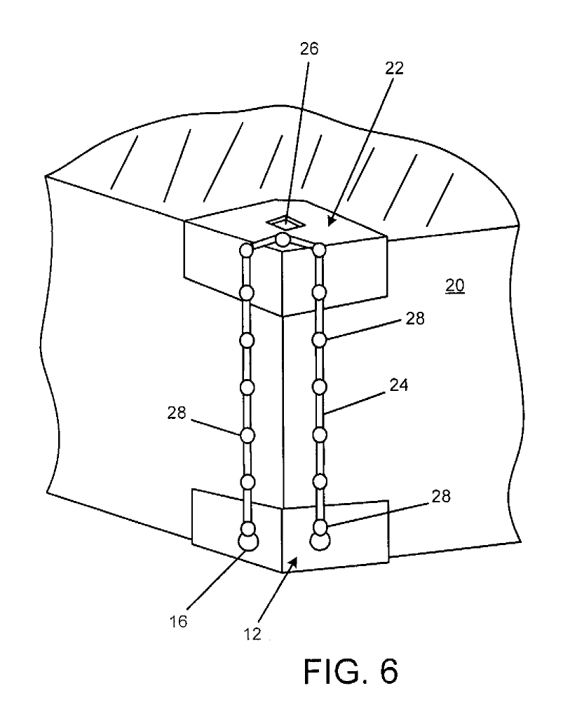

FIG. 6 is a plan view illustration of a medical instrument sterilization container corner protector 10, in accordance with the first exemplary embodiment of the present disclosure. Specifically, FIG. 6 illustrates the two corner protector structures 12 illustrated in FIG. 5 in a working position abutting a container 20, with a retaining mechanism 24 engaged between the corner protector structures 12. Although only two corner protector structures 12 are illustrated, it is noted that many other variations of the corner protector 10 are anticipated. For example, a plurality of corner protector structures 12 may be used with one or a plurality of containers. This may include 2, 4, 8 or any other number of corner protector structures 12 retained on the corners of any number of containers. Any number of fastening structures 16 may be used with the corner protector structures 12 to provide successful retention of the corner protector structures 12 to the container 20 with the retaining mechanism 24. Possible configurations of retaining mechanisms 24 may include straight, diagonal, looped or webbed designs.

In accordance with the first exemplary embodiment of the present disclosure, the corner protector 10 may also be designed to allow the corner protector structure 12 to be turned inside out, or otherwise manipulated, and placed in a position abutting a substantially curved corner of a container 20. This may allow a corner protector structure 12 to be used with a container with a substantially square-edged corner, as well as a container with a substantially round-edge corner, and may be achieved by a corner protector structure 12 that is constructed from a flexible and resilient material. A corner protector structure 12 having this design may be more versatile for uses with medical sterilization containers having a variety of corner shapes. Accordingly, the other features of the corner protector 10, including but not limited to the base 13 and sidewall 14 of the corner protector structure 12, the fastening structure 16 and retaining mechanism 24, may be usable with either of the abovementioned configurations of the corner protector 10.

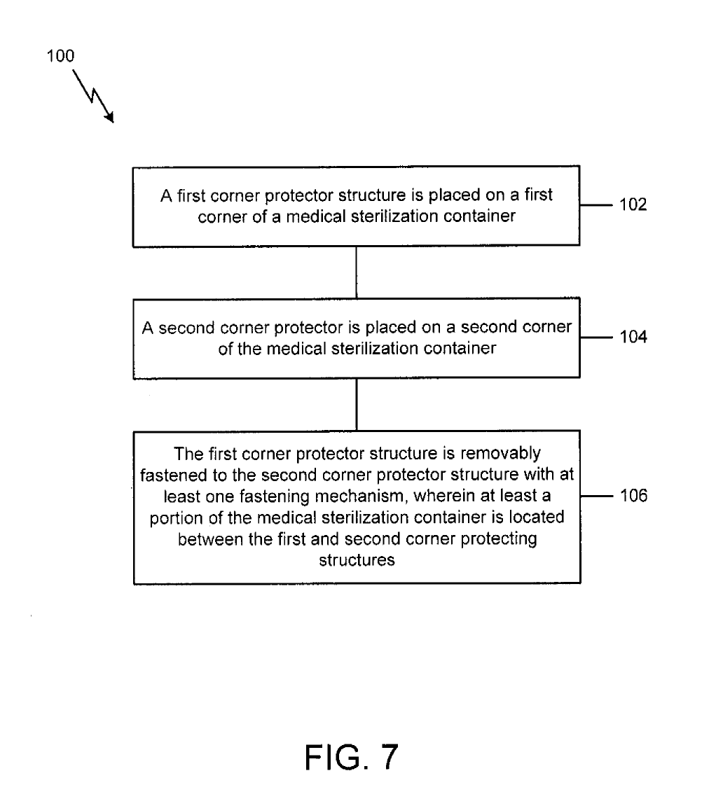

FIG. 7 is a flow chart 100 illustrating a method of protecting a corner of a medical sterilization container 20, in accordance with the first exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 102, a first corner protector structure 12 is placed on a first corner of a medical sterilization container 20. A second corner protector structure 12 is placed on a second corner of the medical sterilization container 20 (Block 104). The first corner protector structure 12 is removably fastened to the second corner protector structure 12 with at least one fastening mechanism 24, wherein at least a portion of the medical sterilization container 20 is located between the first and second corner protecting structures 12 (Block 106). Additional steps may also be included in the method. For example, the method may include the step of selecting one of a plurality of fastening structure engagement elements positioned along a length of the fastening mechanism to engage with the first and second corner protector structures 12, wherein the selected fastening structure engagement element corresponds to at least one of a height dimension, a length dimension, and a width dimension of the medical sterilization container 20. The method may also include the step of wrapping the medical sterilization container 20 having the first corner protector structure 12 and the second corner protector structure 12 with a bacteria-resistant material.

It should be emphasized that the above-described embodiments of the present disclosure, particularly, any “preferred” embodiments, are merely possible examples of implementations merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A medical sterilization container corner protector comprising:
a corner protector structure sized to removably engage with a corner of the medical sterilization container;
a fastening structure disposed on the corner protector; and
a fastening mechanism engaged with the fastening structure, wherein the fastening mechanism biases the corner protector towards the corner of the medical sterilization container.

2. The medical sterilization container corner protector of claim 1, wherein the fastening mechanism further comprises an elastic, flexible stringer.

3. The medical sterilization container corner protector of claim 1, wherein the corner protector structure further comprises a base and at least one sidewall.

4. The medical sterilization container corner protector of claim 3, wherein at least one of the base and sidewall has a textured surface.

5. The medical sterilization container corner protector of claim 4, wherein the textured surface further comprises a plurality of raised surfaces and a plurality of non-raised surfaces, wherein the plurality of non-raised surfaces are accessible by a quantity of moving atmospheric gas.

6. The medical sterilization container corner protector of claim 3, wherein the base has at least one cutout element.

7. The medical sterilization container corner protector of claim 1, wherein the fastening mechanism further comprises a first portion, a second portion, and a third portion located between the first and second portions, wherein the first portion of the fastening mechanism is engaged with the fastening structure at a first location, the second portion of the fastening mechanism is engaged with the fastening structure at a second location, and the third portion is at least partially retained against the medical sterilization container.

8. The medical sterilization container corner protector of claim 1, wherein the corner protector structure is at least partially constructed from a flexible, resilient material.

9. A medical sterilization container corner protector comprising:
at least a first corner protector structure and a second corner protector structure, each of the first and second corner protector structures having a base and at least one sidewall, wherein each of the first and second corner protector structures are sized to removably engage with a first corner and a second corner, respectively, of the medical sterilization container;
at least a first fastening structure disposed on the first corner protector structure;
at least a second fastening structure disposed on the second corner protector structure;
a fastening mechanism engagable between the first and second fastening structures, wherein the fastening mechanism biases each of the first and second corner protectors towards the first and second corners, respectively, of the medical sterilization container.

10. The medical sterilization container corner protector of claim 9, further comprising a third corner protector structure sized to removably engage with a third corner of the medical sterilization container, wherein the fastening mechanism is engagable between at least one of the first and second fastening structures and a fastening structure within the third corner protector.

11. The medical sterilization container corner protector of claim 9, wherein the first and second corner protector structures have a textured surface.

12. The medical sterilization container corner protector of claim 9, wherein the first and second corner protector structures have a cutout element within the base.

13. The medical sterilization container corner protector of claim 9, wherein at least one of the first and second fastening structures further comprise a keyhole element.

14. The medical sterilization container corner protector of claim 9, wherein the fastening mechanism further comprises an elongated, elastic, flexible stringer.

15. The medical sterilization container corner protector of claim 14, further comprising at least one fastening structure engagement element positioned along a length of the elongated, elastic, flexible stringer.

16. The medical sterilization container corner protector of claim 15, wherein the at least one fastening structure engagement element is engagable with the first and second fastening structures at a selectable position, wherein the selectable position corresponds to at least one of a height dimension, a length dimension, and a width dimension of the medical sterilization container.

17. The medical sterilization container corner protector of claim 9, further comprising a stacking element formed on the base of at least one of the first and second corner protector structures proximate to the medical sterilization container, wherein the stacking element is engagable with a third corner protector structure positioned about a second medical sterilization container when stackably configured in relation to the medical sterilization container.

18. A method for protecting a corner of a medical sterilization container, the method comprising:
placing a first corner protector structure on a first corner of a medical sterilization container;
placing a second corner protector structure on a second corner of the medical sterilization container; and
removably fastening the first corner protector structure to the second corner protector structure with at least one fastening mechanism, wherein at least a portion of a medical sterilization container is located between the first and second corner protecting structures.

19. The method of protecting a corner of a medical sterilization container of claim 18, further comprising the step of selecting one of a plurality of fastening structure engagement elements positioned along a length of the fastening mechanism to engage with the first and second corner protector structures, wherein the selected fastening structure engagement element corresponds to at least one of a height dimension, a length dimension, and a width dimension of the medical sterilization container.

20. The method of protecting a corner of a medical sterilization container of claim 18, further comprising the step of wrapping the medical sterilization container having the first corner protector structure and the second corner protector structure with a bacteria-resistant material.
